(19) United States
(12) Patent Application Publication
(10) Pub. No.: US 2006/0005465 A1
(43) Pub. Date: Jan. 12, 2006

(54) Organic colloidal dispersion of essentially monocrystalline praticles of at least one compound based on at least one rare earth, a process for its preparation, and use thereof

(76) Inventors: Gilbert Blanchard, Lagny Le Sec (FR); Jean-Yves Chane-Ching, Eaubonne (FR); Veronique Besse, Paris (FR)

Correspondence Address: Jean-Louis SEUGNET;Rhodia Inc., 259 Prospect Plains Road, Cranbury, NJ, 08512, US

(21) Appl. No.: 11/222,603

(22) Filed: Sep. 9, 2005

Related U.S. Application Data
(62) Division of application No. 10/048,883, filed on Jul. 25, 2002, now abandoned.

(30) Foreign Application Priority Data
Aug. 4, 1999 (FR) 99/10133

(51) Int. Cl. C10L 10/06; C10L 10/00; B01F 3/12; C09K 3/32

(52) U.S. Cl. 44/602; 44/640; 516/89

(57) ABSTRACT

The invention concerns an organic colloidal dispersion comprising: particles of at least a compound based on at least a rare earth, at least an acid, and at least a diluent, characterised in that at least 90% of the particles are monocrystalline. The invention also concerns the method for preparing said dispersion and its use as additive of diesel fuel for internal combustion engines.

The present invention relates to an organic colloidal dispersion comprising essentially monocrystalline particles of at least one compound based on at least one rare earth, and to a process for its preparation. The invention also concerns the use of this dispersion as a gas oil additive for internal combustion engines.

During combustion of gas oil in the diesel engine, carbonaceous products tend to form soot, which is known to be noxious both to the environment and to health. Techniques for reducing the emission of such carbonaceous particles, hereinafter termed “soot”, have long been researched.

Such research is accompanied by the requirement that the emission of carbon monoxide and toxic and mutagenic gas such as oxides of nitrogen must not increase.

Many solutions for reducing such carbonaceous emissions have been proposed.

One solution which would be satisfactory consists of introducing catalysts into the soot to allow frequent self-ignition of the soot collected on a filter. To this end, the soot has to have a sufficiently low self-ignition temperature that is frequently achieved during normal operation of the engine.

It has been observed that colloidal dispersions of rare earth(s) can constitute a good element for reducing the soot self-ignition temperature.

In order to be used in a conventional manner and to satisfy industrial demands, the colloidal dispersions should have good dispersibility in the medium into which they are introduced, high stability over time and high catalytic activity at a relatively low concentration.

Known colloidal dispersions do not always satisfy all of those criteria. They may, for example, have good dispersibility but not sufficient stability, or good stability but the catalytic activity requires concentrations that are too high to be of economic interest.

The principal aim of the invention is to provide colloidal dispersions that have a stability over time and increased catalytic activity at relatively low concentrations.

The present invention concerns an organic colloidal dispersion comprising particles of at least one compound based on at least one rare earth and in which at least 90% of said particles are monocrystalline, at least one acid and at least one diluent.

It also concerns a process for preparing said dispersions in which particles of at least one compound of at least one rare earth are synthesised in an aqueous phase then transferred into an organic phase.

The invention also concerns the use of said dispersions as a gas oil additive for internal combustion engines.

One advantage of the colloidal dispersions of the invention is that they are constituted by essentially monocrystalline particles resulting in the production of stable dispersions.

The dispersions of the invention have a further advantage, namely a fine particle size with a narrow size distribution. This grain size contributes, inter alia, to a substantial improvement in the stability of the dispersions.

This stability means not only when the colloidal dispersion is concentrated but also when it is diluted.

Further, the dispersions of the invention provide good dispersibility in the medium into which they are introduced.

Further characteristics, details and advantages of the invention will become apparent from the following description and illustrative examples and figures.

The present invention concerns an organic colloidal dispersion comprising:
particles of at least one compound based on at least one rare earth;
at least one acid; and
at least one diluent;

characterized in that at least 90% of the particles are monocrystalline.

The following definitions are used in the description:

The expression “colloidal dispersion of a compound based on a rare earth” means any system constituted by fine solid particles with colloidal dimensions based on said compound, in suspension in a liquid phase, said particles optionally also containing residual quantities of bound or adsorbed ions such as nitrates, acetates, citrates or ammonium ions. It should be noted that in such dispersions, the rare earth can be either completely in the form of a colloid or simultaneously in the form of ions and in the form of colloids.

Within the context of the invention, the term “monocrystalline” particles means particles that are individual and constituted by a single crystallite (or at least appear to be constituted by a single crystallite) when the dispersion is examined by TEM (high resolution transmission electron microscopy).

It is also possible to use the technique of cryo-TEM to determine the state of aggregation of the elementary particles. It allows transmission electron microscopy (TEM) to be used on samples that are kept frozen in their natural medium, which is either water or organic diluents such as aromatic or aliphatic solvents, for example Solvesso or Isopar, or certain alcohols such as ethanol.

Freezing is carried out on thin films about 50×100 nm thick either in liquid ethane for aqueous samples or in liquid nitrogen for others.

Cryo-TEM preserves the state of dispersion of the particles and is representative of that state in the actual medium.

The term “rare earth” means elements of the group constituted by yttrium, scandium, and elements from the periodic table with atomic numbers in the range 57 to 71. The periodic table referred to in the description is that published in the “Supplément au Bulletin Chimique de France”, n° 1 (January 1966).

Regarding the rare earth, this can more particularly be selected from cerium, lanthanun, yttrium, neodymium, gadolinium and praseodymium. Preferably, the rare earth is selected from cerium, lanthanum, yttrium and praseodymium.

As indicated above, the colloidal dispersions of the invention can comprise at least one compound based on at least one rare earth. Said compound can thus be based on two or more rare earths, which may be identical or different.

In the case of a compound based on at least two rare earths, which may be identical or different, said rare earths can have different oxidation numbers. The oxidation number of rare earths is generally equal to or in the range +3 to +4.

In an advantageous implementation of the invention, the colloidal dispersions can also comprise at least one other element (E) selected from groups IIA, IVA, VIIA, IB, IIB, IIIB and IVB of the periodic table.

The following can more particularly be mentioned in this regard: iron, copper, strontium, zirconium, titanium, gallium, palladium and manganese.

Regarding the respective proportions of the elements in the composition of the compound(s) mentioned above, in the case of the presence of at least one rare earth with at least one element (E), the proportion of rare earth(s) is preferably at least 10 mole %, more particularly at least 20 mole %, and still more particularly at least 50 mole % with respect to the total number of moles of rare earth element(s) and element (E), expressed as the oxide.

The composition of said compound(s) is supplemented by one or more element(s) (E) at 100 mole % with respect to the total number of moles of rare earth element(s) and elements (E), expressed as the oxide.

As already mentioned, the particles in the dispersions of the invention have a fine grain size with a narrow size distribution. They have a d₅₀ in the range 1 to 5 nm, preferably in the range 2 to 3 nm.

In the present description, the grain size characteristics are usually referred to as of the type dₙ, where n is a number from 1 to 99. This notation designates the particle size for which the size of n % by number of said particles is equal to that size or lower. As an example, a d₅₀ of 3 nanometres means that the size of 50% by number of the particles is 3 nanometres or less.

The grain size is determined by transmission electron microscopy (TEM) in a conventional manner, using a sample that had been dried on a carbon membrane supported on a copper screen.

This preparation technique is preferred as it allows more precise measurement of the particle size. The zones selected for the measurements are those with a dispersion state similar to that observed with cryo-TEM.

In addition to the particles mentioned above, the organic colloidal dispersion of the invention comprises at least one acid, advantageously an amphiphilic acid. The acid contains 10 to 50 carbon atoms, preferably 15 to 25 carbon atoms.

These acids can be linear or branched. They may be aryl, aliphatic or arylaliphatic acids, optionally carrying other functions provided that these functions are stable in the media in which the dispersions of the present invention are to be used. As an example, aliphatic carboxylic acids, aliphatic sulphonic acids, aliphatic phosphonic acids, alkylarylsulphonic acids and alkylarylphosphonic acids can be used, either natural or synthetic. Clearly, it is possible to use a mixture of acids.

Examples that can be cited are the following fatty acids: tall oil, soya oil, tallow, linseed oil, oleic acid, linoleic acid, stearic acid and its isomers, pelargonic acid, capric acid, lauric acid, myristic acid, dodecylbenzenesulphonic acid, 2-ethyl hexanoic acid, naphthenic acid, hexoic acid, toluene sulphonic acid, toluene phosphonic acid, lauryl sulphonic acid, lauryl phosphonic acid, palmityl sulphonic acid, and palmityl phosphonic acid.

Within the context of the present invention, the term “amphiphilic acid” can also designate other amphiphilic acids such as polyoxyethylenated alkyl ether phosphates. These are phosphates with formula:

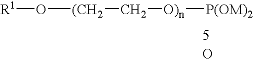

or polyoxyethylenated dialkyl phosphates with formula:

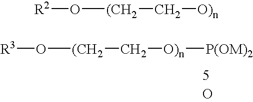

in which:
R¹, R² and R³, which may be identical or different, represent a linear or branched alkyl radical, in particular containing 2 to 20 carbon atoms; a phenyl radical; an alkylaryl radical, more particularly an alkylphenyl radical, in particular with an alkyl chain containing 8 to 12 carbon atoms; or an arylalkyl radical, more particularly a phenylaryl radical;
n represents the number of ethylene oxide moieties, for example 0 to 12;
M represents a hydrogen, sodium or potassium atom.

Radical R¹ can in particular be a hexyl, octyl, decyl, dodecyl, oleyl or nonylphenyl radical.

Examples of this type of amphiphilic compound are those sold under the trade marks Lubrophos® and Rhodafac® sold by Rhodia, in particular the following products:
Rhodafac® RA 600, polyoxyethylene (C8-C10) alkyl phosphate ethers;
Rhodafac® RA 710, or RS410 polyoxyethylene tridecyl phosphate ether;
Rhodafac® PA 35, polyoxyethylene oleocetyl phosphate ether;
Rhodafac® PA 17, polyoxyethylene nonylphenyl phosphate ether;
Rhodafac® RE 610, polyoxyethylene (branched) nonyl phosphate ether.

The colloidal dispersions of the invention also comprise at least one diluent. The diluent will be selected taking into account the acid used, the heating temperature and the final application of the colloidal dispersion.

The diluent can be an apolar hydrocarbon. Examples that can be cited are aliphatic hydrocarbons such as hexane, heptane, octane, nonane, inert cycloaliphatic hydrocarbons such as cyclohexane, cyclopentane, cycloheptane, aromatic hydrocarbons such as benzene, toluene, ethylbenzene, xylenes and liquid naphthenes. Further suitable substances are Isopar or Solvesso (registered trade mark from EXXON) type petroleum cuts, in particular Solvesso 100, which essentially contains a mixture of methylethyl- and trimethyl-benzene, Solvesso 150, which comprises a mixture of alkylbenzenes, in particular dimethylbenzene and tetramethylbenzene, and Isopar, which essentially contains iso- and cyclo-paraffinic C11 and C12 hydrocarbons.

It is also possible to use chlorinated hydrocarbons such as chloro- or dichlorobenzene, chlorotoluene. Ethers and aliphatic and cycloaliphatic ketones, such as diisopropyl ether, dibutyl ether, methylisobutylketone, diisobutylketone, mesityl oxide, can also be used.

The diluent can be used alone or in the form of a mixture of diluents.

The proportion of acid and diluent with respect to the rare earth compound is adjusted to obtain a stable dispersion. Clearly, when the dispersion contains an element (E) as mentioned above in addition to the rare earth(s), the proportion of acid and diluent will be adjusted with respect to the total rare earth(s) and element(s) present.

The concentration of rare earth compound(s) in the dispersions of the invention can be up to 40% by weight of rare earth oxide(s) with respect to the total dispersion weight.

In the particular implementation of the invention in which at least one element (E) is also present, the concentration of rare earth compound(s) and element(s) (E) can be up to 40% by weight of rare earth oxide(s) and element(s) (E) with respect to the total dispersion weight. This concentration is preferably in the range 1% to 32% by weight of rare earth oxide(s) and element(s) (E) with respect to the total dispersion weight.

The dispersions of the invention have excellent stability. No decantation is observed after several months or even years.

The present invention also encompasses the process for preparing said dispersions.

In this process, the particles are synthesised in an aqueous phase then transferred into an organic phase, advantageously with no drying step.

This process comprises the following steps:
a) preparing an aqueous mixture comprising at least one soluble salt, preferably an acetate and/or a nitrate, of the element or elements forming part of the composition of the particles to be obtained;
b) bringing the aqueous mixture of step a) into contact with a basic medium to form a reaction mixture the pH of which is kept basic;
c) at the end of step b), recovering a precipitate or an aqueous colloidal dispersion;
d) bringing either the aqueous colloidal dispersion of step c) or the precipitate recovered in step c), optionally re-dispersed, into contact with at least one acid and a diluent, to obtain an organic colloidal dispersion.

The first step of the process (step a)) consists of preparing an aqueous mixture, normally in the form of a solution or dispersion, of the element(s) forming the composition of particles to be obtained. This mixture comprises at least one soluble salt, preferably a rare earth acetate and/or a nitrate, and optionally at least one salt of element (E) selected from groups IIA, IVA, VIIA, VIII, IB, IIB, IIIB and IVB of the periodic table.

The next step (step b)) consists of bringing the above aqueous mixture into contact with a basic medium. The term “basic medium” means any medium with a pH of more than 7. The basic medium is normally an aqueous solution containing a base. Hydroxide type substances can in particular be used as the base. Alkaline or alkaline-earth hydroxides can be cited. It is also possible to use secondary, tertiary or quaternary amines. However, amines and ammonia are preferred since they reduce the risks of pollution by alkaline or alkaline-earth cations. Urea can also be mentioned.

The above mixture and the basic medium are brought into contact under conditions such that the pH of the reaction mixture formed remains basic and constant. The pH of the reaction mixture is kept to a value of at least 7, more particularly at least 7.5, still more particularly in the range 7.5 to 10.5.

The aqueous mixture and basic medium are brought into contact by introducing said mixture into the basic medium. It is possible to bring them into contact under continuous conditions, satisfying the pH criterion by adjusting the respective flow rates of the mixture and basic medium.

In a particular implementation of the invention, it is possible to operate under conditions such that during contact of the mixture with the basic medium, the pH of the reaction formed is kept constant. Such conditions can be obtained by adding a supplemental quantity of base to the reaction mixture formed when introducing the mixture to the basic medium.

Contact is normally carried out at ambient temperature. This contact can advantageously be effected in an atmosphere of air or nitrogen or a nitrogen-air mixture.

At the end of the reaction, a precipitate or an aqueous colloidal dispersion is recovered (step c)).

When a precipitate is obtained, it is optionally possible to separate this precipitate from the mother liquor by filtering, centrifuging or any other suitable separation means known to the skilled person. The precipitate will advantageously be moist. The separated product can be washed.

Preferably, the precipitate does not undergo a drying step or freeze-drying step or any operation of this type.

In the remainder of the process, the precipitate can be used as it is, or optionally after taking it up again in an aqueous suspension.

The aqueous colloidal dispersion directly obtained from step b), the precipitate separated from the mother liquors in its moist form, or the precipitate taken up again into an aqueous suspension, is then brought into contact with at least one acid and a diluent, as defined above (step d)).

The concentration of total oxides (oxides of rare earth elements and element (E)) in the aqueous colloidal dispersion used in step d) can be in the range 20 g/l to 300 g/l, preferably in the range 50 g/l to 150 g/l.

When in step d) the precipitate is used in its moist form, the proportion of oxides of said precipitate can be in the range 10% to 50% by weight with respect to the mass of moist precipitate. The percentages of total oxides can be determined by loss on ignition, for example by calcining at 1000° C.

To obtain an organic colloidal dispersion in step d), either the aqueous colloidal dispersion of step c) or the precipitate, optionally re-dispersed, is brought into contact with at least one acid and a diluent. The quantity of acid to be incorporated can be defined by the mole ratio r:

$$r = \frac{number of moles of acid}{number of moles of rare earth element ( s )}$$

This mole ratio can be in the range 0.2 to 0.8, preferably in the range 0.3 to 0.6.

The quantity of diluent to be incorporated is adjusted to obtain a concentration of total oxides as mentioned above.

At this stage, it may be advantageous to add to the organic phase a promoter agent the function of which is to accelerate transfer of particles of the compound(s) from the aqueous phase to the organic phase and to improve the stability of the organic colloidal dispersions obtained.

The promoter agent can be a compound with an alcohol function, more particularly linear or branched aliphatic alcohols containing 6 to 12 carbon atoms. Specific examples that can be cited are 2-ethylhexanol, decanol, dodecanol and mixtures thereof.

The proportion of said agent is not critical and can vary within wide limits. However, a proportion in the range 2% to 15% by weight is generally very suitable.

The order of introducing the reactive elements is of no consequence. The aqueous colloidal dispersion, acid, diluent and optional promoter agent can be mixed simultaneously. It is also possible to pre-mix the acid, diluent and optional promoter agent.

The aqueous colloidal dispersion and organic phase can be brought into contact in a reactor that is in an atmosphere of air, nitrogen or an air-nitrogen mixture.

While contact between the aqueous colloidal dispersion and the organic phase can be carried out at ambient temperature, about 20° C., the temperature is preferably in the range 60° C. to 50° C., advantageously in the range 80° C. to 140° C.

In certain cases, because of the volatility of the diluent, the vapours can be condensed by cooling to a temperature below its boiling point.

The resulting reaction mixture (mixture of the aqueous colloidal dispersion, acid, diluent and optional promoter agent) is stirred throughout the heating period, which period can vary.

When heating is stopped, two phases are observed: an organic phase containing the colloidal dispersion, and a residual aqueous phase.

Sometimes, a third emulsion phase is observed.

The organic phase and aqueous phase are then separated using conventional separation techniques: decanting, centrifuging.

In accordance with the present invention, organic colloidal dispersions are obtained with the characteristics cited above.

The organic colloidal dispersions described above can be used as a gas oil additive for internal combustion engines, more particularly as an additive for diesel engine gas oils.

They can also be used as combustion aids in fuels or liquid fuels for energy generators such as explosion engines, domestic oil burners or reaction engines.

Finally, the invention relates to fuels for internal combustion engines obtained by mixing a conventional fuel with an organic colloidal dispersion in accordance with the invention.

The following examples and figures are given by way of illustration and do not limit the present invention.

### FIGURES

FIG. 1: Photograph obtained by TEM of an organic colloidal dispersion of CeO₂ in accordance with the invention, prepared as described in Example 1.

FIG. 2: Photograph obtained by TEM of a prior art organic colloidal dispersion of CeO₂, prepared as described in Example 7.

### EXAMPLES

### Example 1

### Preparation of an Organic Colloidal Solution of CeO₂ Produced From Cerium (III) Acetate

In this example, the preparation of an organic colloidal solution of cerium oxide comprised the following steps:

1) producing a solid precipitate in an aqueous phase;

2) transfer to an organic phase.

1). Production of a Solid Precipitate in an Aqueous Phase

1800 ml of deionised water was added to 279.3 g of crystalline cerium (III) acetate (49.29% CeO₂ oxide equivalents), sold by Rhodia Terres Rares. The crystalline salt was dissolved over about an hour with stirring.

22.8 ml of pure acetic acid from Prolabo was then added, and the volume was adjusted to 2000 ml. After homogenising, the pH of the solution was 4.3. The concentration of this cerium (III) acetate solution was then 0.4 M with a CH₃COOH/Ce(III) mole ratio of 0.5.

The solid was precipitated in a continuous apparatus comprising:

a one litre reactor provided with a paddle stirrer adjusted to 400 rpm, with a stock of 0.5 l of basic solution (NH₄OH, pH 10.5) and an electrode controlling a pH regulating pump set to a pH of 10.5;
two supply flasks, one containing the cerium acetate solution described above and the other containing a 6N ammonia solution; the flow rate of the cerium acetate solution was fixed at 500 ml/h and the flow rate of the ammonia was controlled to regulate the pH;
an extraction system (pump) to adjust the volume in the reactor to 0.5 litres and connected to a second reactor in series with the first reactor;
a second reactor to recover the precipitate formed.

The precipitate was recovered by centrifuging (12 min at 3000 rpm). The oxide content was determined by loss on ignition: the CeO₂ content was about 23%.

The precipitate was taken up into suspension in deionised water to a concentration of 50 g/l of CeO₂.

2). Transfer into Organic Phase

340 ml of the aqueous suspension described above was introduced into a 2 litre jacketed reactor equipped with a thermostatted bath.

An organic phase containing 136.1 g of Isopar sold by EXXON and 16.9 g of isostearic acid (AIS) that had already been dissolved was added at ambient temperature and with stirring.

The stirring speed was fixed at 150 rpm, and the reaction medium was heated to 88° C. and kept at that temperature for 4 hours. An emulsion phase was observed to form in the reactor.

After separation in a 40 g separating funnel, the upper brown organic phase was recovered. This organic phase was centrifuged at 4500 rpm for 10 minutes, then filtered through a hydrophobic membrane.

Characteristics of the Organic CeO₇ Colloidal Phase

The concentration of the organic colloidal phase, determined after evaporating off the Isopar and calcining at 1000° C., was 6.4% of CeO₂.

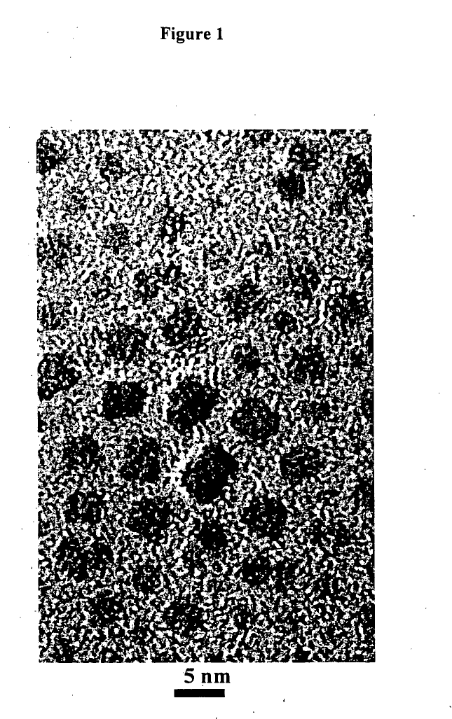

High resolution TEM observation showed that at least 90% of the particles were monocrystalline (FIG. 1).

Said particles had a d₅₀ of 2.5 nm. It was also shown that the size of 80% of the particles was in the range 1 to 4 nm.

### Example 2

### Organic Colloidal Solution of CeO₂ Produced from a Mixture of Cerium (III) Acetate and Cerium (IV) Nitrate

As was the case for Example 1, the preparation of an organic colloidal solution of cerium oxide comprised two steps:

1) producing a solid precipitate in an aqueous phase;

2) transfer to an organic phase.

1). Production of a Solid Precipitate in an Aqueous Phase

1600 ml of deionised water was added to 279.3 g of crystalline cerium (III) acetate (49.29% CeO₂ oxide equivalents), sold by Rhodia Terres Rares. The crystalline salt was dissolved over about an hour with stirring.

22.8 ml of pure acetic acid from Prolabo was then added.

158.1 ml of concentrated nitric acid from Prolabo was added to 148 ml of cerium (IV) nitrate solution (containing 1.35 mole/l of Ce⁴⁺ with a H⁺/Ce⁴⁺ mole ratio of 0.5) solid by Rhodia Terres Rares.

The cerium (IV) nitrate solution so prepared was mixed with the cerium (III) acetate solution at ambient temperature. The volume was adjusted to 2500 ml. The equivalent concentration of CeO₂ was then 0.4 M.

The solid was precipitated in the continuous apparatus described above, with the exception that that the flask for supplying the cerium (III) acetate solution contained the mixture of cerium (III) acetate and cerium (IV) nitrate described above.

The oxide content was determined by loss on ignition: the CeO₂ content was about 29%.

The precipitate was taken up into suspension in deionised water to a concentration of 50 g/l of CeO₂.

2). Transfer into Organic Phase

340 ml of the aqueous suspension described above was introduced into a 2 litre jacketed reactor equipped with a thermostatted bath.

An organic phase containing 136.1 g of Isopar and 16.9 g of isostearic acid (AIS) that had already been dissolved was added at ambient temperature and with stirring.

The stirring speed was fixed at 150 rpm, and the reaction medium was heated to 88° C. and kept at that temperature for 4 hours.

An emulsion phase was observed to form in the reactor.

After separation in a separating funnel, 105 g of the upper brown organic phase was recovered. This organic phase was centrifuged at 4500 rpm for 10 minutes, then filtered through a hydrophobic membrane.

Characteristics of the Organic CeO₂ Colloidal Phase

The concentration of the organic colloidal phase, determined after evaporating off the Isopar and calcining at 1000° C., was 8.9% of CeO₂.

As described in the preceding example, high resolution TEM observation showed that at least 90% of the particles were monocrystalline. Said particles had a d₅₀ of 3 nm.

### Example 3

### Organic Colloidal Solution of CeO₂ Produced from a Mixture of Cerium (III) Acetate and Iron (III) Nitrate

As was the case for Example 1, the preparation of an organic colloidal solution of cerium oxide comprised two steps:

1) producing a solid precipitate in an aqueous phase;

2) transfer to an organic phase.

1). Production of a Solid Precipitate in an Aqueous Phase

Preparation of Iron Acetate Solution

An iron (III) nitrate solution was prepared containing 0.5 mole/l of Fe, i.e., 206.1 g of 98% pure Fe(NO₃)₃,9H₂O sold by Prolabo, adjusted to 1 litre. 270 ml of 10% NH₄OH was added to the iron nitrate solution with stirring, using a perstaltic pump at a flow rate of 10 ml/min, until the pH reached 7.

The precipitate was centrifuged at 4500 rpm for 12 min, then taken up into suspension to the initial volume using demineralised water. It was stirred for 15 minutes. It was taken up into suspension again to an equivalent final volume.

The pH of the dispersion was 6.5. A volume of 100 ml of 100% acetic acid from Prolabo was then added, the pH of the dispersion was 2.7. The percentage of oxide, determined by loss on ignition, was 2.84% of Fe₂O₃.

Preparation of Co-acetate Solution

1790 ml of deionised water was added to 312.6 g of crystalline cerium (III) acetate (49.29% CeO₂ oxide equivalents), sold by Rhodia Terres Rares. The crystalline salt was dissolved over about an hour with stirring.

15 g of pure acetic acid from Prolabo and 610.5 ml of the previously prepared iron acetate solution were then added to the cerium acetate solution, followed by 84.7 ml of deionised water. 2500 ml of a solution of co-acetates was obtained with a pH of 4.6.

The solid was precipitated in the continuous apparatus described above, except that the flask for supplying the cerium (III) acetate solution contained the mixture of cerium (III) acetate and iron (III) acetate described above and that precipitation was carried out under nitrogen.

The oxide content of the precipitated product was determined by loss on ignition (total oxide content about 16%). The precipitate was taken up into suspension in deionised water to a concentration of 50 g/l of CeO₂.

2). Transfer into Organic Phase

340 ml of the aqueous suspension described above was introduced into a 2 litre jacketed reactor equipped with a thermostatted bath.

An organic phase containing 134.1 g of Isopar sold by EXXON and 18.9 g of isostearic acid (AIS) that had already been dissolved was added at ambient temperature and with stirring.

The stirring speed was fixed at 150 rpm, and the reaction medium was heated to 88° C. and kept at that temperature for 4 hours.

After separation in a separating funnel, an upper brown organic phase was recovered. This organic phase was centrifuged at 4500 rpm for 10 minutes, then filtered through a hydrophobic membrane.

Characteristics of the Organic CeO₂—Fe₂O₃ Colloidal Phase

The concentration of the organic colloidal phase, determined after evaporating off the Isopar and calcining at 1000° C., was 6.73% of total oxide (0.8CeO₂-0.2 Fe₂O₃)

High resolution TEM observation showed that at least 90% of the particles were monocrystalline. Said particles had a d₅₀ of 2.5 nm. It was also observed that the particle size was in the range 2 to 4 nm.

### Example 4

### Organic Colloidal Solution of CeO₂ Produced from a Mixture of Cerium (III) Acetate and TiOCl₂

The preparation of an organic colloidal solution of cerium oxide comprised two steps:

1) producing a solid precipitate in an aqueous phase;

2) transfer to an organic phase.

1). Production of a Solid Precipitate in an Aqueous Phase

20.5 ml of 100% acetic acid from Prolabo, 1432.6 ml of deionised water and 97.3 g of TiOCl₂ solution (1.84 mole/kg of Ti, Cl=6.63 mole/kg, d=1.286, giving Cl/Ti=3.6) were added to 250.13 g of hydrated cerium (III) acetate containing 49.29% CeO₂ oxide sold by Rhodia Terres Rares.

The pH of the mixture after adding 150 ml of 2M HCl and 140 ml of 36% concentrated HCl was 0.5. The volume was adjusted to 2000 ml with 181.2 g of demineralised water.

The solid was precipitated in the continuous apparatus described above. The reactor was supplied with a stock of 0.5 l of deionised water previously adjusted to a pH of 10.5. The electrode was connected to a pH regulating pump set at a pH of 10.5.

One of the two supply flasks contained the cerium salt solution described above and the other contained a 6N ammonia solution. The flow rate of the cerium acetate solution was fixed at 500 ml/h and the flow rate of the ammonia was controlled to regulate the pH.

The precipitate was recovered by centrifuging (12 min at 3000 rpm). The oxide content was determined by loss on ignition: the oxide content was about 16.5%. The precipitate was taken up into suspension in deionised water to a concentration of 50 g/l of CeO₂.

2). Transfer into Organic Phase

340 ml of the aqueous suspension described above was introduced into a 2 litre jacketed reactor equipped with a thermostatted bath. An organic phase containing 134.1 g of Isopar sold by EXXON and 18.9 g of isostearic acid (AIS) that had already been dissolved was added at ambient temperature and with stirring.

The stirring speed was fixed at 150 rpm, and the reaction medium was heated to 88° C. and kept at that temperature for 4 hours.

After stopping the stirring, an upper brown organic phase was observed, which was recovered after transfer and separation in a separating funnel. This organic phase was centrifuged at 4500 rpm for 10 minutes, then filtered through a hydrophobic membrane.

The concentration of the organic colloidal phase, determined after evaporating off the Isopar and calcining at 1000° C., was 6.58% in terms of the oxides.

High resolution TEM observation showed that at least 90% of the particles were monocrystalline. Said particles had a d₅₀ of 3 nm. It was also observed that the particle size was in the range 2 to 4 nm.

### Example 5

### Organic Colloidal Solution of CeO₂ Produced from a Mixture of Cerium (III) Acetate and ZrO(NO₃)₂

The preparation of an organic colloidal solution of cerium oxide comprised two steps:

1) producing a solid precipitate in an aqueous phase;

2) transfer to an organic phase.

1). Production of a Solid Precipitate in an Aqueous Phase

20.3 ml of 100% acetic acid from Prolabo and 1356 ml of deionised water were added to 236.7 g of hydrated cerium (III) acetate containing 49.29% CeO₂ oxide sold by Rhodia Terres Rares. 150 ml of concentrated HNO₃ from Prolabo and 60.3 ml of ZrO(NO₃)₂ solution sold by Anan Kasei (23.32% of ZrO₂, and d=1.49) were then added.

The pH of the mixture after stirring was 0.5. The volume was adjusted to 2000 ml with 181.2 g of demineralised water.

The solid was precipitated in the continuous apparatus described above. The reactor was supplied with a stock of 0.5 l of deionised water previously adjusted to a pH of 10.5. The electrode was connected to a pH regulating pump set at a pH of 10.5.

The two supply flasks contained the cerium salt solution described above and a 6N ammonia solution. The flow rate of the cerium acetate solution was fixed at 500 ml/h and the flow rate of the ammonia was controlled to regulate the pH.

The precipitate was recovered by centrifuging (12 min at 3000 rpm). The oxide content was determined by loss on ignition: the oxide content was about 21%. The precipitate was taken up into suspension in deionised water to a concentration of 50 g/l of CeO₂.

2). Transfer into Organic Phase

325 ml of the aqueous suspension described above was introduced into a 2 litre jacketed reactor equipped with a thermostatted bath. An organic phase containing 165.5 g of Isopar and 17 g of isostearic acid (AIS) that had already been dissolved was added at ambient temperature and with stirring.

The stirring speed was fixed at 150 rpm, and the reaction medium was heated to 88° C. and kept at that temperature for 4 hours.

After stopping the stirring, an emulsion was observed. After separating in a separating funnel, an upper brown organic phase was recovered. This organic phase was centrifuged at 4500 rpm for 10 minutes, then filtered through a hydrophobic membrane.

The concentration of the organic colloidal phase, determined after evaporating off the Isopar and calcining at 1000° C., was 7.35% in terms of the oxides.

High resolution TEM observation showed that at least 90% of the particles were monocrystalline. Said particles had a d₅₀ of 2.5 nm. It was also observed that the particle size was in the range 2 to 4 nm.

### Example 6 (Comparative)

### Prior Art Organic Colloidal Dispersion Based on Cerium-Iron

This example concerns the preparation of a cerium-iron compound in respective proportions of 90/10 by oxide weight.

The starting material was an iron acetate solution obtained from iron nitrate by precipitation in ammonia at a pH of 7, then washing the precipitate and re-dissolving in acetic acid at a pH of 1.5.

A 70 g/l mixture of cerium acetate and iron in solution with a 90/10 oxide ratio was formed. It was continuously reacted with a 4 M ammonia solution. The respective flow rates of the solution and ammonia were 24 ml/min and 36 ml/min. The pH of the reaction medium was 11.

The precipitate obtained was dried with a Büchi spray drier with an outlet temperature of 110° C.

20 g of Ce/Fe oxide (90/10 oxide weight) in the spray dried hydrate form was taken up in 200 ml of water to obtain a 100 g/l aqueous colloidal dispersion. To form 100 g of organic sol, 10 g of isostearic acid was diluted in 70 g of Solvesso 150 to obtain an isostearic acid/oxide mole ratio of 0.3 and a final concentration of mixed oxide in the organic phase of 20%.

The organic phase was brought into contact with the aqueous phase with gentle stirring (100 rpm) then the mixture was heated under reflux (100° C. to 103° C.) for 4 hours.

After decanting, the organic phase charged with cerium and iron was filtered through a hydrophobic filter then it could be centrifuged at 4500 rpm.

The concentration of organic colloidal phase, determined after evaporating off the Solvesso and calcining at 1000° C., was 19% in terms of the oxide.

High resolution TEM observation could not show that at least 90% of the particles were monocrystalline. The colloidal dispersion obtained was principally constituted by particles of 4 to 8 nm and some particles were 20 to 30 nm.

### Example 7 (Comparative)

### Prior Art Organic Colloidal Dispersion

The organic cerium sol was synthesised in two steps:

1) production of a colloidal dispersion of cerium in an aqueous phase;

2) transfer into organic phase.

1/ Production of a colloidal dispersion of cerium in an aqueous chase

415 ml of a cerium (IV) nitrate solution (1.4 mole/l; 0.58 mole/l of free acid, d=1.433) was neutralised with 835 ml of a 0.64 mole/l ammonia solution to obtain a final solution containing 80 g/l of pre-neutralised CeO₂ with a [OH]/[Ce] of 0.5.

The solution was then placed in an autoclave, heated to 150° C. for one hour then kept at 150° C. for 4 hours. After cooling, the hydrate obtained was filtered and the oxide content was determined by loss on ignition at 1000° C.

40 g of hydrated cerium oxide was taken up in 250 ml of deionised water to obtain an aqueous colloidal dispersion with a concentration of 160 g/l.

2/ Transfer into Organic Phase

To form 100 g of colloidal dispersion, 19.9 g of isostearic acid (AIS) was diluted in 40.1 g of Solvesso to obtain a final AIS/Ce mole ratio of 0.3 and a final CeO₂ concentration in the organic phase of 40%.

The organic phase was brought into contact with the aqueous phase with gentle stirring then the mixture was heated under reflux (100-103° C.) for 15 hours.

After decanting, the organic phase was filtered through a hydrophobic filter then it could be centrifuged at 4500 rpm.

The colloidal dispersion obtained, with a concentration of 40% by weight of cerium oxide, was clear black in colour.

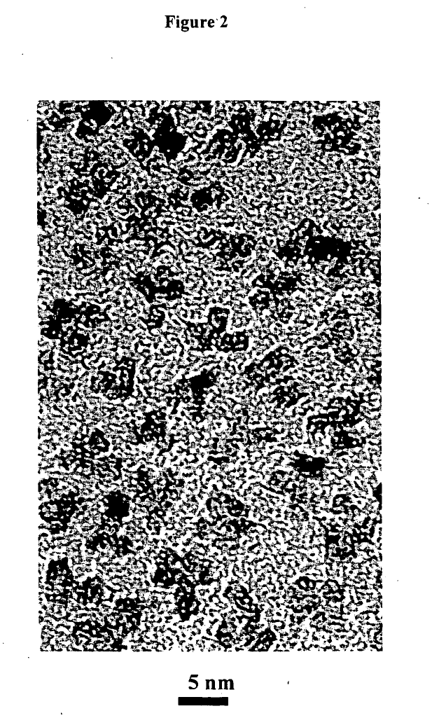

High resolution TEM showed that the particles were not monocrystalline (FIG. 2), but that 80% of the particles were constituted by 3 or 4 crystallites.

### Example 8

### Evaluation of Additives Described in Examples 1 to 7 Using a Test Engine

The test engine was as follows: a 2.4 l Daimler-Benz 240 D diesel engine, atmospheric with a manual gearbox, was placed on a dynamometric rig. The exhaust line was provided with a particle filter (CORNING EX 47 5.66×6.00). The temperature of the exhaust gases was measured at the particle filter inlet using thermocouples. The pressure differential between the particle filter inlet and outlet was also measured.

The additive was added to the fuel to produce an amount of 50 ppm of metal with respect to the supplemented fuel.

The particle filter was charged with particles by carrying out 2 consecutive cycles corresponding to the cycle described by the 7 modes in Table 1.

TABLE 1
“7 mode” charging cycle

| Mode | Speed (rpm) | Charge (max %) | Torque (Nm) | Duration (min) |
|---|---|---|---|---|
| 1 | idling | — | 0 | 5 |
| 2 | 3000 | 10 | 11 | 10 |
| 3 | 3000 | 25 | 28 | 10 |
| 4 | idling | — | 0 | 10 |
| 5 | 4300 | 10 | 10 | 10 |
| 6 | 4300 | 25 | 25 | 10 |
| 7 | idling | — | 0 | 5 |

The engine speed was then fixed to correspond to a speed of 90 km/h in fourth gear. The charge at constant engine speed was then increased to raise the temperature of the exhaust gases.

The pressure drop created by the particle filter increased initially due to the increase in temperature then it reached a maximum before dropping again due to combustion of the carbonaceous materials accumulated on the particle filter. The point (marked by its temperature) at which the pressure drop no longer increased was considered to be representative of the regeneration point of the particle filter by the additive.

A test carried out with no additive in the fuel provided the reference value.

Test Engine Results Obtained with Additives Described in Examples 1 to 7

| Additive reference | Additive composition | T_{regeneration} (° C.) |
|---|---|---|
| 1 | CeO₂ | 491 |
| 2 | CeO₂ | 489 |
| 3 | Ce/Fe (80/20) | 465 |
| 4 | Ce/Ti (80/20) | 472 |
| 5 | Ce/Zr (80/20) | 485 |
| 6 (prior art) | Ce/Fe (90/10) | 546 |
| 7 (prior art) | Ce (100) | 545 |
| — | None | 600 |

The results obtained using the test engine with the additives of the invention and those of the prior art show that the regeneration temperature of a particle filter is significantly reduced when the accumulated particles have been generated from a fuel supplemented with an organic dispersion of the present invention.

It can also be concluded that for the same dose of additive (50 ppm of metal with respect to the supplemented fuel), the dispersions of the present invention perform better.

1-16. (canceled)

17. An organic colloidal dispersion comprising:
particles of at least one compound based on at least one rare earth,
at least one acid, and
at least one diluent,
wherein at least 90% of the particles are monocrystalline.

18. A colloidal dispersion according to claim 17, wherein the rare earth is selected from the group consisting of cerium, lanthanum, yttrium, neodymium, gadolinium and praseodymium.

19. A colloidal dispersion according to claim 17, wherein the compound is based on at least two rare earths, which may be identical or different, said rare earths having different oxidation numbers.

20. A colloidal dispersion according to claim 17, comprising at least one further element (E) selected from the group consisting of the elements of groups IIA, IVA, VIIA, IB, IIB, IIIB or IVB of the periodic table.

21. A colloidal dispersion according to claim 20, wherein the element (E) is selected from the group consisting of iron, copper, strontium, zirconium, titanium, gallium, palladium and manganese.

22. A colloidal dispersion according to claim 20, comprising at least 10 mole % of rare earth(s) with respect to number of moles of rare earth(s) and element (E), expressed as oxide.

23. A colloidal dispersion according to claim 22, comprising at least 20 mole % of rare earth(s) with respect to number of moles of rare earth(s) and element (E), expressed as oxide.

24. A colloidal dispersion according to claim 23, comprising at least 50 mole % of rare earth(s) with respect to the total number of moles of rare earth(s) and element (E), expressed as oxide.

25. A colloidal dispersion according to claim 17, wherein the particles have a d₅₀ of from 1 to 5 nm.

26. A colloidal dispersion according to claim 25, wherein the d₅₀ is of from 2 to 3 nm.

27. A dispersion according to claim 17, wherein the acid is an amphiphilic acid.

28. A colloidal dispersion according to claim 17, wherein the diluent is an apolar hydrocarbon.

29. A colloidal dispersion according to claim 17, comprising at most 40%, by rare earth oxide(s) weight, of rare earth(s), with respect to the total dispersion weight.

30. A colloidal dispersion according to claim 20, comprising at most 40%, by rare earth and element (E) oxide(s) weight, of rare earth(s) and element(s) (E), with respect to the total dispersion weight.

31. A colloidal dispersion according to claim 20, comprising from 1 to 32%, by rare earth and element (E) oxide(s) weight, of rare earth(s) and element(s) (E), with respect to the total dispersion weight.

32. A process for preparing an organic colloidal dispersion comprising:
particles of at least one compound based on at least one rare earth,
at least one acid, and
at least one diluent,
wherein at least 90% of the particles are monocrystalline, comprising the following steps:
a) preparing an aqueous mixture comprising at least one soluble salt, of element or elements the particles are based on,
b) bringing the aqueous mixture of step a) into contact with a basic medium to form a reaction mixture, the pH of which being kept basic,
c) at the end of step b), recovering a precipitate or an aqueous colloidal dispersion, and
d) bringing either the aqueous colloidal dispersion of step c) or the precipitate recovered in step c), optionally re-dispersed, into contact with at least one acid and a diluent, to obtain an organic colloidal dispersion.

33. A process according to claim 32, wherein the soluble salt in step a) is an acetate or a nitrate.

34. A process according to claim 32, wherein the basic medium in step b) is an ammonia solution.

35. A process according to claim 32, wherein the pH in step b) is of at least 7.

36. A process according to claim 35, wherein the pH is of at least 7.5.

37. A process according to claim 36, wherein the pH is of from 7.5 to 10.5.

38. Gas oil for internal combustion engines, comprising additives, wherein at least one additive is an organic colloidal dispersion comprising:
particles of at least one compound based on at least one rare earth,
at least one acid, and
at least one diluent,
wherein at least 90% of the particles are monocrystalline.

39. A fuel for internal combustion engines, obtained by mixing a normal fuel with an organic colloidal dispersion comprising:
particles of at least one compound based on at least one rare earth,
at least one acid, and
at least one diluent,
wherein at least 90% of the particles are monocrystalline.
